(19) United States
(12) Patent Application Publication
(10) Pub. No.: US 2024/0184632 A1
(43) Pub. Date: Jun. 6, 2024

(54) A METHOD AND APPARATUS FOR ENHANCED TASK GROUPING

(71) Applicant: Nokia Technologies Oy, Espoo (FI)

(72) Inventors: Yu YOU, Tampere (FI); Sujeet Shyamsundar MATE, Tampere (FI); Kashyap KAMMACHI SREEDHAR, Tampere (FI)

(21) Appl. No.: 18/554,959

(22) PCT Filed: Mar. 23, 2022
(86) PCT No.: PCT/IB2022/052671

§ 371 Date: Oct. 11, 2023

Related U.S. Application Data
(60) Provisional application No. 63/176,481, filed on Apr. 19, 2021.

(51) Int. Cl. G06F 9/50

(52) U.S. Cl. CPC G06F 9/5038

(57) ABSTRACT

Various embodiments provide an apparatus, a method, and a computer program product. The apparatus includes at least one processor; and at least one non-transitory memory including computer program code; wherein the at least one memory and the computer program code are configured to, with the at least one processor, cause the apparatus at least to perform: define one or more task group types, wherein the one or more task group types comprise one or more of: a first at least one task group which enables executing a workflow comprising one or more tasks in the first at least one task group in a synchronous mode; and a second at least one task group which enables executing a sub-workflow or another workflow including the at least one task in the second at least one task group in an asynchronous mode.

### TECHNICAL FIELD

The examples and non-limiting embodiments relate generally to network based media processing, and more particularly, to method and apparatus for enhanced task grouping.

### BACKGROUND

It is known to provide network based media processing.

### SUMMARY

An example apparatus includes at least one processor; and at least one non-transitory memory including computer program code; wherein the at least one memory and the computer program code are configured to, with the at least one processor, cause the apparatus at least to perform: define one or more task group types, wherein the one or more task group types comprise one or more of: a first at least one task group which enables executing a workflow comprising one or more tasks in the first at least one task group in a synchronous mode; and a second at least one task group which enables executing a sub-workflow or another workflow comprising at least one task in the second at least one task group in an asynchronous mode.

The example apparatus may further include, wherein the one or more tasks in the first at least one task group in the synchronous mode are executed simultaneously.

The example apparatus may further include, wherein the synchronous mode comprises simultaneous allocation of one or more resources for the one or more tasks and the first at least one task group in the workflow.

The example apparatus may further include, wherein the asynchronous mode comprises possibility for allocation of resources and execution of the second at least one task group in the sub-workflow or the another workflow at a later scheduled time than the start of the workflow or the another workflow.

The example apparatus may further include, wherein the second at least one task group comprises at least one task corresponding to a subset of the workflow or the another workflow which are executed in a step mode.

The example apparatus may further include, wherein the apparatus is further caused to define a scope, wherein the scope comprises a local scope or a global scope, and wherein a task group associated with the local scope is scheduled and instantiated by the control plane depending on the resource condition and requirements of a single workflow, and wherein a task group associated with the global scope is scheduled, allocated and executed based on the resource requirements corresponding to a predefined threshold number of workflows. In an embodiment, the threshold number of workflows include other workflows or all workflows.

The example apparatus may further include, wherein the first at least one task group and the second at least one task group reside or are executed in at least one of: a network based media processing (NBMP) source; a central cloud; or a multi-access edge computing (MEC) cloud or a sink device.

The example apparatus may further include, wherein a task group is a logical group of tasks that are deployed on a same MPE (media processing entity), or MPEs that are within a predetermined distance.

The example apparatus may further include, wherein a task group comprises one or more tasks running in one or more MPEs.

The example apparatus may further include, wherein an MPE hosts one or more task groups.

The example apparatus may further include, wherein a task group is defined in a workflow description from a network based media processing source, and wherein edges of a directed acyclic graph (DAG) defines a boundary or a start and end point of a task group.

The example apparatus may further include, wherein the at the first at least one task group and the at least one second task group comprises one or more of following parameters: a breakable parameter determines whether or not a connected task is splitable, when the connected task is splitable, the connected task is used to define the boundary of the at the first at least one task group and the at least one second task group; a mode parameter indicates whether a task group is executed in synchronous mode or in asynchronous mode; a replicable flag parameter indicates that the tasks within the task group are capable of being replicated by a workflow manager or the task group is capable of being divided into new task groups for new replicated tasks; or a step descriptor enables at least one of a stateless processing or a parallelization of a task or a task group.

The example apparatus may further include, wherein a workflow manager groups global task groups identifiers from multiple workflows with the same identifier together and synchronize executions of tasks associated with the global task groups identifiers in each execution window.

The example apparatus may further include, wherein the workflow manager uses the first at least one task group or the second at least one task group to schedule resources.

An example method includes: defining one or more task group types, wherein the one or more task group types comprise one or more of: a first at least one task group which enables executing a workflow comprising one or more tasks in the first at least one task group in a synchronous mode; and a second at least one task group which enables executing a sub-workflow or another workflow comprising at least one task in the second at least on task group in an asynchronous mode.

The example method may further include, wherein the one or more tasks in the first at least one task group in the synchronous mode are executed simultaneously.

The example method may further include, wherein the synchronous mode comprises simultaneous allocation of one or more resources for the one or more tasks and the first at least one task group in the workflow.

The example method may further include, wherein the asynchronous mode comprises possibility for allocation of resources and execution of the second at least one task group in the sub-workflow or the another workflow at a later scheduled time than the start of the workflow or the another workflow.

The example method may further include, wherein the second at least one task group comprises at least one task corresponding to a subset of the workflow or the another workflow which are executed in a step mode.

The example method may further include defining a scope, wherein the scope comprises a local scope or a global scope, and wherein a task group associated with the local scope is scheduled and instantiated by the control plane depending on the resource condition and requirements of a single workflow, and wherein a task group associated with the global scope is scheduled, allocated and executed based on the resource requirements corresponding to a predefined threshold number of workflows. In an embodiment, the threshold number of workflows include other workflows or all workflows.

The example method may further include, wherein the first at least one task group and the second at least one task group reside or are executed in at least one of: a network based media processing (NBMP) source; a central cloud; or a multi-access edge computing (MEC) cloud or a sink device.

The example method may further include, wherein a task group is a logical group of tasks that are deployed on a same media processing entity (MPE), or MPEs that are within a predetermined distance.

The example method may further include, wherein a task group comprises one or more tasks running in one or more MPEs.

The example method may further include, wherein an MPE hosts one or more task groups.

The example method may further include, wherein a task group is defined in a workflow description from a network based media processing source, and wherein edges of a directed acyclic graph (DAG) defines a boundary or start and an end point of a task group.

The example method may further include, wherein the at the first at least one task group and the at least one second task group comprises one or more of following parameters: a breakable parameter determines whether or not a connected task is splitable, when the connected task is splitable, the connected task is used to define the boundary of the at the first at least one task group and the at least one second task group; a mode parameter indicates whether a task group is executed in synchronous mode or in asynchronous mode; a replicable flag parameter indicates that the tasks within the task group are capable of being replicated by a workflow manager or the task group is capable of being divided into new task groups for new replicated tasks; or a step descriptor enables at least one of a stateless processing or a parallelization of a task or a task group.

The example method may further include, wherein a workflow manager groups global task groups identifiers from multiple workflows with the same identifier together and synchronize executions of tasks associated with the global task groups identifiers in each execution window.

The example method may further include, wherein the workflow manager uses the first at least one task group or the second at least one task group to schedule resources.

An example computer readable medium includes program instructions for causing an apparatus to perform at least the following: defining one or more task group types, wherein the one or more task group types comprise one or more of: a first at least one task group which enables executing a workflow comprising one or more tasks in the first at least one task group in a synchronous mode; and a second at least one task group which enables executing a sub-workflow or another workflow comprising at least one task in the second at least one task group in an asynchronous mode.

The example computer readable medium may further include, wherein the computer readable medium comprises a non-transitory computer readable medium.

The example computer readable medium may further include, wherein the computer readable medium further causes the apparatus to perform the methods as described in any of the previous paragraphs.

Another example apparatus includes: at least one processor; and at least one non-transitory memory including computer program code; wherein the at least one memory and the computer program code are configured to, with the at least one processor, cause the apparatus at least to perform: define a workflow comprising: a first task group comprising one or more tasks in a synchronous mode; and a second task group comprising one or more tasks in an asynchronous mode.

The example apparatus may further include, wherein the one or more tasks in the first at least one task group in the synchronous mode are executed simultaneously.

The example apparatus may further include, wherein the synchronous mode comprises simultaneous allocation of one or more resources for the one or more tasks and the first at least one task group in the workflow.

The example apparatus may further include, wherein the asynchronous mode comprises possibility for allocation of resources and execution of the second at least one task group in the sub-workflow or the another workflow at a later scheduled time than the start of the workflow or the another workflow.

Another example method includes: defining a workflow comprising: a first task group comprising one or more tasks in a synchronous mode; and a second task group comprising one or more tasks in an asynchronous mode.

The example method may further include, wherein the one or more tasks in the first at least one task group in the synchronous mode are executed simultaneously.

The example method may further include, wherein the synchronous mode comprises simultaneous allocation of one or more resources for the one or more tasks and the first at least one task group in the workflow.

The example method may further include, wherein the asynchronous mode comprises possibility for allocation of resources and execution of the second at least one task group in the sub-workflow or the another workflow at a later scheduled time than the start of the workflow or the another workflow.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram of an apparatus that may be configured in accordance with an example embodiment.

FIG. 5 illustrates an example network based media processing (NBMP) environment, in accordance with an embodiment.

FIG. 6 depicts a network based media processing workflow including one or more tasks, in accordance with an embodiment.

FIG. 7 illustrates one or more example techniques of task grouping, in accordance with an embodiment.

FIG. 8 illustrates a relationship between task groups and MPEs, in accordance with an embodiment.

FIGS. 9A and 9B illustrate task group parallelization, by adding splitter and merger before and after the task groups, in accordance with an embodiment.

FIG. 10 is a diagram illustrating a synchronized execution configuration in which multi-workflow execution is synchronized, in accordance with an embodiment.

FIG. 11 illustrates synchronous task group execution, in accordance with an embodiment.

FIG. 12 illustrates asynchronous task group execution, in accordance with an embodiment.

FIG. 13 illustrates a task group before replication, in accordance with an embodiment.

FIG. 14A illustrates task group after replication, in accordance with an embodiment.

FIG. 14B illustrates task group after replication, in accordance with another embodiment.

FIG. 15 is a diagram illustrating an example apparatus, which may be implemented in hardware and configured to implement mechanisms for enhanced task grouping for network-based media processing, in accordance with an embodiment.

FIG. 16 is a flowchart illustrating operations performed for implementing mechanisms for enhanced task grouping for network-based media processing, in accordance with an embodiment.

FIG. 17 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth
5G fifth
5GC 5G core network
ACC accuracy
AI artificial intelligence
AIOT AI-enabled IoT
a.k.a. also known as
AMF access and mobility management function
AVC advanced video coding
CABAC context-adaptive binary arithmetic coding
CDMA code-division multiple access
CE core experiment
CU central unit
DASH dynamic adaptive streaming over HTTP
DCT discrete cosine transform
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
gNB (or gNodeB) base station for 5G/NR, for example, a node providing NR user plane and control plane protocol terminations towards the UE, and connected via the NG interface to the 5GC
GSM Global System for Mobile communications
H.222.0 MPEG-2 Systems is formally known as ISO/IEC 13818-1 and as ITU-T Rec. H.222.0
H.26x family of video coding standards in the domain of the ITU-T
HLS high level syntax
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
ISO International Organization for Standardization
ISOBMFF ISO base media file format
ITU International Telecommunication Union
ITU-T ITU Telecommunication Standardization Sector
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
MCD MPE capability description
mdat MediaDataBox
MME mobility management entity
MMS multimedia messaging service
moov MovieBox
MP 4 file format for MPEG-4 Part 14 files
MPE media processing entity
MPEG moving picture experts group
MPEG-2 H.222/H.262 as defined by the ITU
MPEG-4 audio and video coding standard for ISO/IEC 14496
MSB most significant bit
NAL network abstraction layer
NBMP network-based media processing
NDU NN compressed data unit
ng or NG new generation
ng-eNB or NG-eNB node providing NR user plane and control plane protocol terminations towards the UE, and acting as secondary node in EN-DC
NN neural network
NNEF neural network exchange format
NNR neural network representation
NR new radio (5G radio)
N/W or NW network
ONNX Open Neural Network exchange
PB protocol buffers
PC personal computer
PDA personal digital assistant
PDCP packet data convergence protocol
PHY physical layer
PID packet identifier
PLC power line communication
PSNR peak signal-to-noise ratio
RAM random access memory
RAN radio access network
RFC request for comments
RFID radio frequency identification
RLC radio link control
RRC radio resource control
RRH remote radio head
RU radio unit
Rx receiver
SDAP service data adaptation protocol
SGW serving gateway
SMF session management function
SMS short messaging service
st(v) null-terminated string encoded as UTF-8 characters as specified in ISO/IEC 10646
SVC scalable video coding
S1 interface between eNodeBs and the EPC
TCP-IP transmission control protocol-internet protocol
TDMA time divisional multiple access
trak TrackBox
TS transport stream
TV television
Tx transmitter
UE user equipment
ue(v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator UTF-8 8-bit Unicode Transformation Format
WDD workflow description document
WLAN X2 wireless local area network interconnecting interface between two eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are described in accordance with an example embodiment in order to provide mechanism for enhanced task grouping in a network based media processing environment.

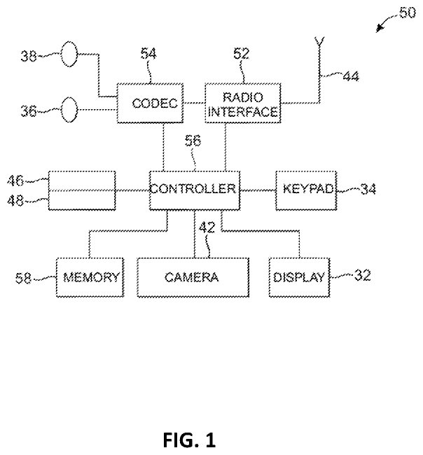

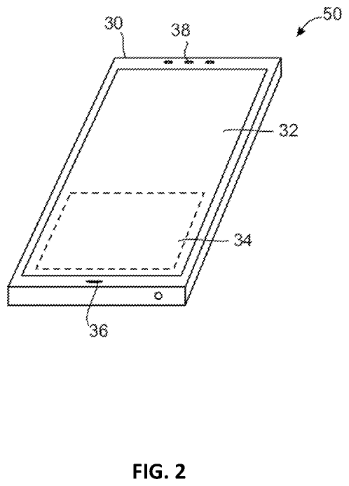

The following describes in detail suitable apparatus and possible mechanisms for network based media processing according to embodiments. In this regard reference is first made to FIG. 1 and FIG. 2, where FIG. 1 shows an example block diagram of an apparatus 50. The apparatus may be an Internet of Things (IOT) apparatus configured to perform various functions, for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The electronic device 50 may for example be a mobile terminal or user equipment of a wireless communication system, a sensor device, a tag, or a lower power device. However, it would be appreciated that embodiments of the examples described herein may be implemented within any electronic device or apparatus which may process data in communication network.

The apparatus 50 may comprise a housing 30 for incorporating and protecting the device. The apparatus 50 may further comprise a display 32, for example, in the form of a liquid crystal display, light emitting diode display, organic light emitting diode display, and the like. In other embodiments of the examples described herein the display may be any suitable display technology suitable to display media or multimedia content, for example, an image or a video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, a processor or processor circuitry for controlling the apparatus 50. The controller 56 may be connected to a memory 58 which in embodiments of the examples described herein may store both data in the form of image and audio data, video data, and/or may also store instructions for implementation on the controller 56. The controller 56 may further be connected to codec circuitry 54 suitable for carrying out coding and/or decoding of audio, image, and/or video data or assisting in coding and/or decoding carried out by the controller.

The apparatus 50 may further comprise a card reader 48 and a smart card 46, for example, a UICC and UICC reader for providing user information and being suitable for providing authentication information for authentication and authorization of the user at a network.

The apparatus 50 may comprise radio interface circuitry 52 connected to the controller and suitable for generating wireless communication signals, for example, for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera 42 capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

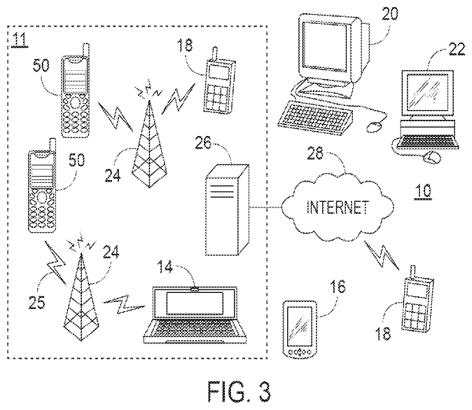

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to, a wireless cellular telephone network (such as a GSM, UMTS, CDMA, LTE, 4G, 5G network, and the like), a wireless local area network (WLAN) such as defined by any of the IEEE 802.x standards, a Bluetooth® personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the Internet 28. Connectivity to the Internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; for example, a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the Internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IOT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called internet of things (IOT) devices. IoT may be defined, for example, as an interconnection of uniquely identifiable embedded computing devices within the existing Internet infrastructure. The convergence of various technologies has and may enable many fields of embedded systems, such as wireless sensor networks, control systems, home/building automation, and the like, to be included the IoT. In order to utilize Internet IoT devices are provided with an IP address as a unique identifier. The IOT devices may be provided with a radio transmitter, such as WLAN or Bluetooth transmitter or a RFID tag. Alternatively, the IOT devices may have access to an IP-based network via a wired network, such as an Ethernet-based network or a power-line connection (PLC).

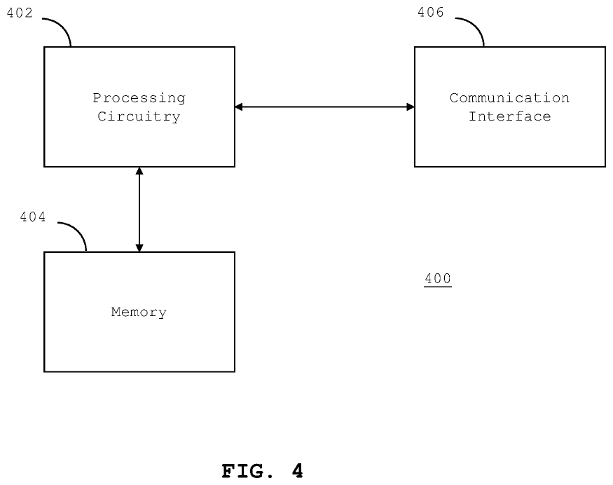

An apparatus 400 is provided in accordance with an example embodiment as shown in FIG. 4. In one embodiment, the apparatus of FIG. 4 may be embodied by a server. In an alternative embodiment, the apparatus may be embodied by an end-user device, for example, by any of the various computing devices described above. In either of these embodiments and as shown in FIG. 4, the apparatus of an example embodiment in includes, is associated with or is communication with processing circuitry 402, one or more memory devices 404, a communication interface 406 and optionally a user interface.

The processing circuitry 402 may be in communication with the memory device 404 via a bus for passing information among components of the apparatus 400. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 400 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 402 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 402 may be configured to execute instructions stored in the memory device 404 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 406 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 400 may optionally include a user interface that may, in turn, be in communication with the processing circuitry 402 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

### Network-Based Media Processing (NBMP)

A network or cloud based multimedia or media processing service facilitates digital media production through workflows that are designed to facilitate various types of media transformations, e.g., transcoding, filtering, content understanding, enhancements, and the like. The processing typically takes initial configuration (e.g., codec parameters) to guide the specific tasks.

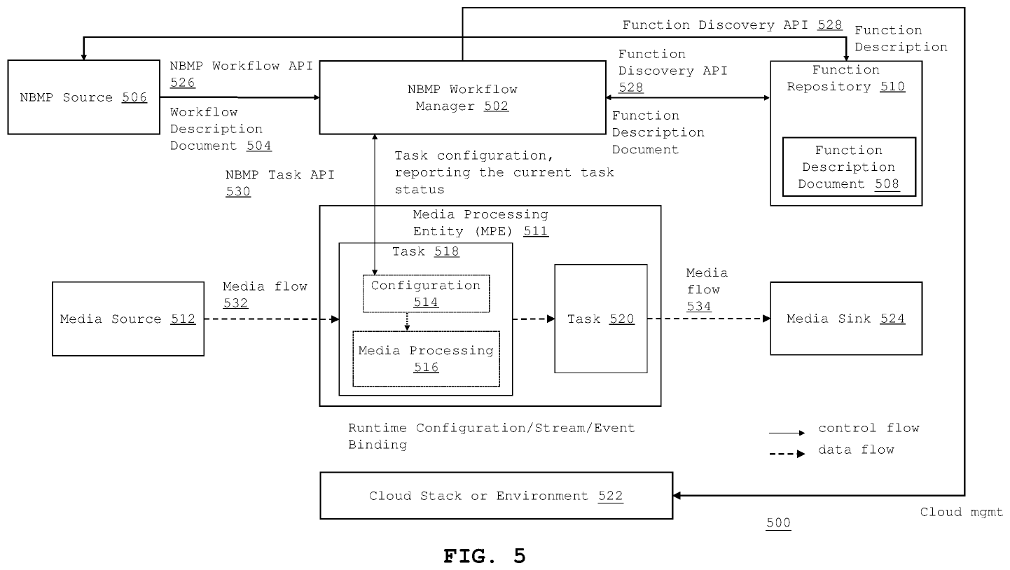

FIG. 5 illustrates an example network based media processing (NBMP) environment 500, in accordance with example embodiments. NBMP enables offloading media processing tasks to the network-based environment like the cloud computing environments 522.

As shown in FIG. 5 there is an NBMP source 506 providing an NBMP workflow API with a workflow description document 504 to an NBMP workflow manager 502, may also be referred to as workflow manager or the manager in some embodiments. As shown in FIG. 5 the NBMP workflow manager 502 is processing the NBMP workflow API with a function repository 510, which includes function description document 508, and the NBMP source 506 is also exchanging a function discovery API 528 and function description with the function repository 510. The NBMP workflow manager 502 provides to a media processing entity (MPE) 511 the NBMP task API 533 including task configuration and reporting the current task status. The media processing entity (MPE) 511 processes the media flow 532 from the media source 512 using a task 518 and task 520 configuration 514. A media flow 534 is output towards a media sink 524. The operations at 526 and 528 include control flow operations, and the operations 532, and 534 include data flow operations.

NBMP processing relies on a workflow manager, that can be virtualized, to start and control media processing (e.g., media processing 516). The workflow manager receives a workflow description from the NBMP source, which instructs the workflow manager about the desired processing and the input and output formats to be taken and produced, respectively.

The workflow manager creates a workflow based on the workflow description document (WDD) that it receives from the NBMP Source. The workflow manager selects and deploys the NBMP Functions into selected media processing entities and then performs the configuration of the tasks. The WDD can include a number of logic descriptors.

The NBMP can define APIs and formats such as Function templates and workflow description document consisting of a number of logic descriptors. NBMP uses the so-called descriptors as the basic elements for its all resource documents such as the workflow documents, task documents, and function documents. Descriptors are a group of NBMP parameters which describe a set of related characteristics of Workflow, Function or Task. Some key descriptors are general, input, output, processing, requirements, configuration, and the like.

In order to hide workflow internal details from the NBMP Source, all updates to the workflow are performed through Workflow Manager. The manager is the single point of access for the creation or change of any workflows. Workflows represent the processing flows defined in WDD provided by NBMP Source (e.g., the client). A workflow can be defined as a chain of tasks, specified by the “connection-map” object in the Processing Descriptor of the WDD.

The workflow manager use may pre-determined implementations of media processing functions and use them together to create the media processing workflow. NBMP defines a function discovery API that it uses with a function repository to discover and load the desired Functions.

A function, once loaded, becomes a task, which is then configured by the workflow manager through the task API and can start processing incoming media. It is noted that a cloud and/or network service providers can define their own APIs to assign computing resources to their customers.

There is an increasing deployment of distributed processing infrastructure where the processing nodes or MPEs (in NBMP context) can be located in the cloud or the edge or even on the end user device. One example of such a use case is the split-rendering process employed in cloud gaming services.

Leveraging such a distributed environment requires that an MPE, which is the task execution context, to span over different processing entities.

The exploitation of the distributed environment can range from moving a task or a workflow, partially or entirely, from one infrastructure to another. For example, transferring a last rendering task in a workflow from edge to an end user device or vice versa.

The NBMP Technology considers the following requirements for the design and development of NBMP:
It may be possible for the NBMP Source to influence the NBMP workflow:
   i. To control the workload split between the sink and the network
   ii. To dynamically adjust the workload split based on changes in client status and conditions
   iii. It may be possible to support streaming of media and metadata from the network to the sink in different formats that are appropriate to the different workload sharing strategies

### Splitting Workflow

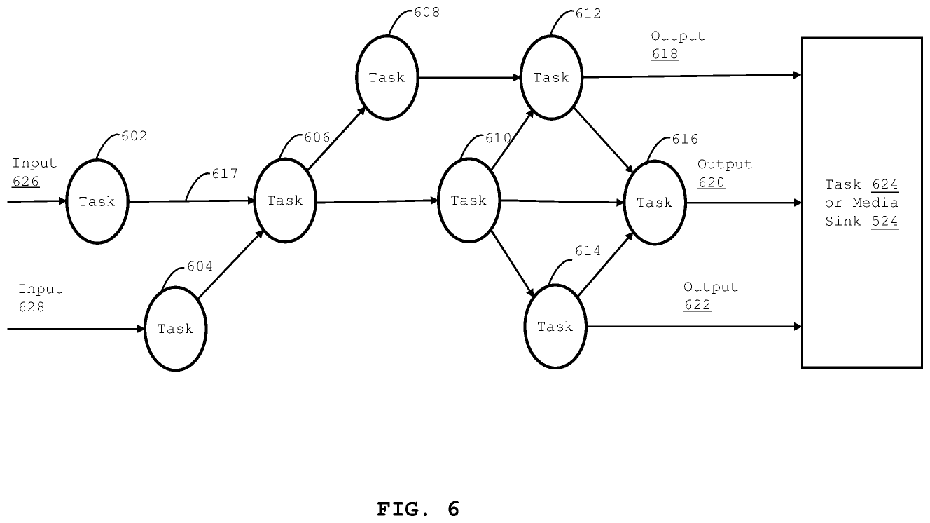

FIG. 6, illustrates a network based media processing workflow including of one or more tasks. The arrows represent the media flow from upstream tasks to downstream tasks. The workflow provides a chain of one or more tasks (e.g., tasks 602, 604, 606, 608, 610, 612, 614, and 616) to achieve a specific media processing. The one or more tasks may be sequential, parallel, or both at any level of the workflow. The workflow may be represented as a directed acyclic graph (DAG). Arrows between tasks may represent data, for example, an output 617 is a data (e.g., media data) output of the task 602. Thus, a workflow may be understood as a connected graph of tasks (may also referred to as media processing tasks), each of which performs a media processing operation for delivering media data and related metadata, e.g., outputs 618, 620, and 622, to be consumed by a media sink or other tasks (e.g., the media sink 524 of FIG. 5 or task 624) or other tasks. The inputs (e.g., inputs 626 and 628) to the workflow can be media source (e.g., the media source 512 of FIG. 5).

Following example illustrates a proposed task grouping, in accordance with an embodiment:

| Task id | Group id |
|---|---|
| 1 | X |
| 2 | Y |
| 3 | X |
| 4 | X |
| 5 | |
| 6 | Y |

As shown in above example, tasks 1, 3, and 4 belong to group X while Task 2 and 6 belong to group Y.

In general, if two or more Tasks have the same group id, then they belong to the same group. In an embodiment, the group id can be defined to a task general descriptor.

In an embodiment, a task group is a collection of tasks or function instances that are expected to run on the same cloud node/cluster. In an embodiment, when a set of tasks are grouped, it means tasks in the group are closer to each other than other tasks, e.g., they have a smaller distance. It is a coarser way of defining the proximity of tasks together compare to the distance parameter.

An NBMP client may define the tasks grouping or even the distance parameters based on the characteristics of the workflow, e.g., two tasks should be run closer as working together of these two tasks is more crucial for the workflow than other tasks.

Alternatively, NBMP Client may decide not to define any task groups in the workflow description. The workflow manager, after instantiation of tasks, may provide back one or more task group in the workflow description based on the actual tasks instantiations on one or more MPEs.

Following paragraph provide details of an example of a task group description or task group descriptor in NBMP:

NBMP defines a processing model of the workflow description document (WDD). When scheduling a workflow, NBMP workflow manager estimates the computing resources (e.g., CPUs, GPUs, memories, and the like) and creates media processing entities (MPEs) from the infrastructure provider, e.g., typically a cloud control entity, or an orchestrator. The process of MPE creation is part of the known process called cloud resource provisioning.

In an embodiment, tasks of a workflow may be instantiated by default for the workflow to operate. Further, the tasks need to run simultaneously, which means an underlying platform has to dedicate resource to all tasks of the workflow at the same time. In an embodiment, it may be common to allow some over-provisioning in practice to provide or request extra capacities in terms of the resources like CPUs, memory, and storage.

A workflow can also be grouped into sub-workflows (or task groups), either by the MPEs, by the business logic of the workflow, or by the different types of media processing (e.g., batch processing vs streaming processing).

Such normal provisioning or over-provisioning scenarios for the whole workflow may not use the resources cost-efficiently, because such normal or even over-provisioning may not always be necessary. Current workflow may lack the support of more optimized resource utilization with following factors:
Late or delayed allocation to utilize computing resources in different pricing periods; or shared resource allocation dynamically in peak times (with respect to different pricing models). For example, media processing requests for HW-acceleration like GPU becomes very common with machine/deep learning approaches (e.g., the neural networks). MPEs with GPU support is expensive. But not all tasks in the workflow require GPU-powered MPEs. It would be economically efficient to group tasks and allow delayed task groups instantiation and execution. So those GPU-MPEs can be scheduled at the right time when the input data becomes available, without pre-occupying those expensive resources during the whole life cycle of the workflow.
Peak workload demand with cloud bursting. Within a limited/capped or controlled budget, the number of workflows that can be deployed is limited. When the demand for computing capacity spikes, it is likely the resources for MPEs are running out and creation of new workflows fail (e.g., ‘out of resources’ or other types of failures due to the cost limit). For example, it is sometimes critical to prioritize the workflow resource usage by increasing the capacity of upstream than downstream. NBMP workflow should be flexible to be re-scheduled or pre-scheduled to have the ability to handle such dynamic change of the capacity.

Various embodiments relate to a method, an apparatus and a computer program product for defining multiple task group types, for example:
a task group which enables executing a workflow comprising one or more tasks in a synchronous mode. In an embodiment, the synchronous mode includes simultaneous allocation of resources for all the tasks and task groups in a workflow; and/or
a task group which enables executing a workflow comprising one or more tasks in an asynchronous mode. The asynchronous mode comprises possibility for allocation of resources and execution of one or more task groups in a workflow at a later scheduled time than the start of the workflow.

In an embodiment, a workflow may contain task groups which operate in the synchronous mode. In an alternate embodiment, a workflow may contain task groups which operate in the asynchronous mode. In another embodiment, a workflow may contain multiple task groups in which a subset of task groups operate in the synchronous mode and another subset of task groups operate in the asynchronous mode.

In an embodiment, an asynchronous task group comprises one or more tasks which correspond to a subset of the workflow which can be executed in step mode.

In an embodiment, an asynchronous and/or a synchronous task group may have a scope defined with it. In an example embodiment the scope can be either local or global. A local task group is scheduled and instantiated by the control plane depending on the resource condition and requirements of a single workflow. A global task group on the other hand is scheduled, allocated and executed based on the resource requirements corresponding to a predefined threshold number of workflows.

Terminologies: Following paragraphs provide non limiting examples of some of the terminologies used in various embodiments:
Workflow or pipeline: A sequence of tasks connected as a graph (e.g., DAG) that processes a media data.
NBMP: A network based media processing framework defines the interfaces including both data formats and APIs among the entities connected through the digital networks for media processing. In some embodiments, NBMP may mean Network-based Media Processing as defined in ISO/IEC 23090-8.
MPE (e.g., the MPE 511 in FIG. 5): A media processing entity (MPE) runs processing tasks applied on the media data and the related metadata received from media sources or other tasks. A media processing task is a process applied to media and metadata input(s), producing media data and related metadata output(s) to be consumed by a media sink or other media processing tasks (for example, as shown in FIG. 5).

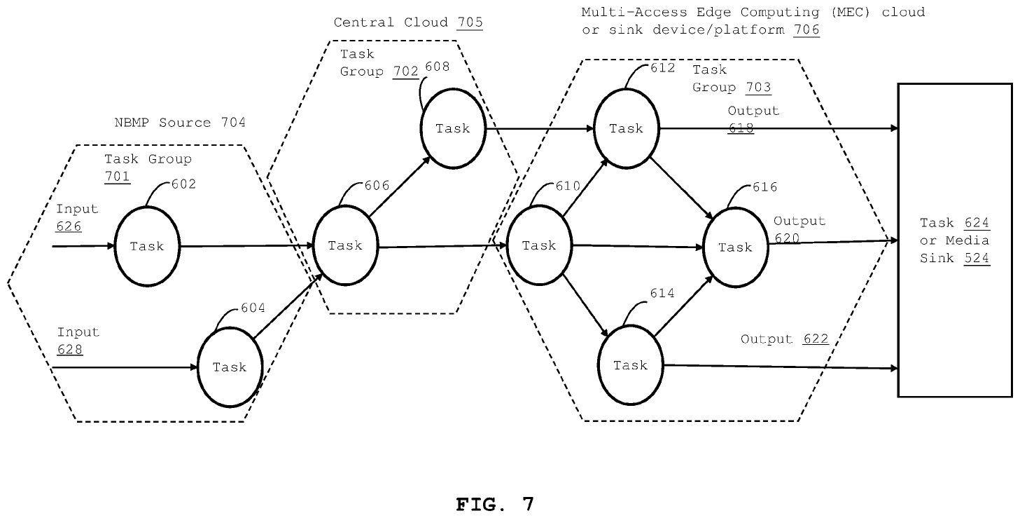

FIG. 7, illustrates one or more example techniques of task grouping, in accordance with an embodiment. FIG. 7 shows three different task groups, for example, a task group 701, a task group 702, and a task group 703. The task group 701 includes the tasks 602 and 604; the task group 702 includes the tasks 606 and 608; and the task group 703 includes the tasks 610, 612, 614, and 616. Functions or details of the inputs 626 and 628; the tasks 602 to 616; the outputs 618, 620, and 622; and the task 624 or the media sink 524 are already explained with reference to FIG. 5 and FIG. 6. In this embodiment, the task group 701 resides or executed in an NBMP source 704, while the task group 702 resides or executed in a central cloud 705, and the task group 703 resides or executed in a multi-access edge computing (MEC) cloud or a sink device 706.

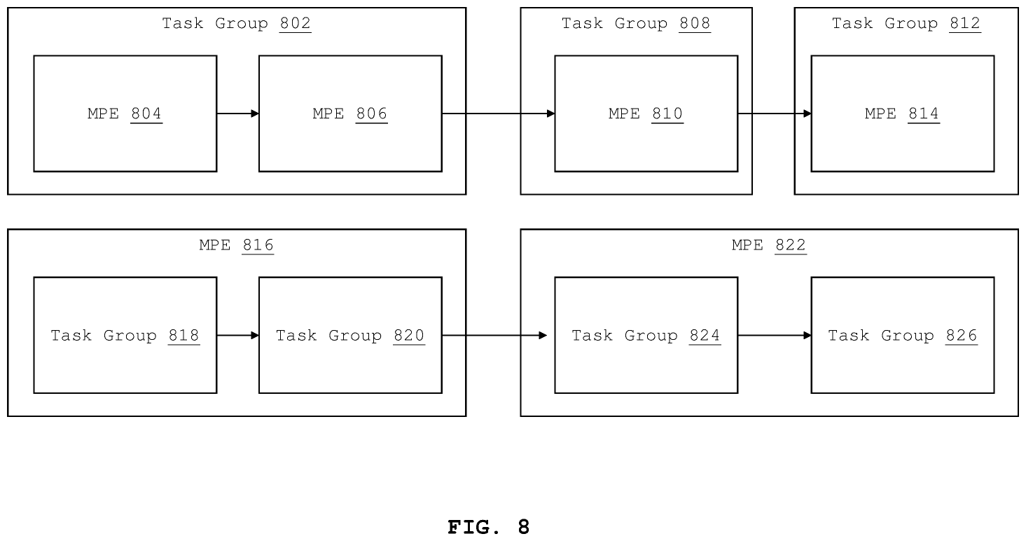

FIG. 8 illustrates a relationship between task groups and MPEs, in accordance with an embodiment. An MPE, for example, the MPE 511 may host multiple tasks. A task Group is a logical group of tasks that are expected to be deployed on the MPEs as close as possible, possibly on the same MPE. FIG. 8 different example ways task groups and MPEs can be defined. A task group can host or include one or more MPEs. For example, as shown in FIG. 8, a task group 802 hosts an MPE 804 and an MPE 806; a task group 808 hosts an MPE 810; a task group 812 hosts an MPE 814. Similarly, an MPE can host one or more task groups. For example, as shown in FIG. 8, an MPE 816 hosts a task group 818 and a task group 820; and an MPE 822 hosts a task group 824 and a task group 826.

In an embodiment, in addition to task IDs of a task-group, a task-group object, or a task group descriptor in NBMP defines the following parameters shown in Table 1.

TABLE 1

| Name | Description | Unit | Type |
|---|---|---|---|
| Id | Group id | identifier | String |
| Tasks | Array of task IDs | Task | Array |
| | | identifier | of |
| | | | String |
| State | Specifies the state of the | State | String |
| | group. The value is one of | | |
| | the workflow/task states: | | |
| | initialized, idle, running, | value | |
| | destroyed, and error. | | |
| Mode | Specifies task group mode. | N/A | String |
| | There are 2 modes: 1) | | or |
| | synchronous mode; 2) | | number |
| | asynchronous mode for | | |
| | flexible task group-based | | |
| | execution and scheduling. The | | |
| | default is synchronous mode. | | |
| Scope | Specifies the scope of the | N/A | String |
| | task group (IDs). The value | | |
| | shall be either ‘local’ or | | |
| | ‘global’ or ‘scopeID’. When | | |
| | the value is ‘local’, the | | |
| | task group ID is valid and | | |
| | scheduled only within the | | |
| | workflow session/lifecycle. | | |
| | When the value is ‘global’, | | |
| | the task groups belonging to | | |
| | the different workflows can | | |
| | be scheduled together by the | | |
| | Workflow Manager. | | |
| | When the value has a specific | | |
| | ‘scopeID’, the task groups | | |
| | belonging to different | | |
| | workflows with the same | | |
| | ‘scopeID’ can be scheduled | | |
| | together by the Workflow | | |
| | Manager. | | |
| Replicable | Specifies the scaling | N/A | Boolean |
| | capability when the type is | | |
| | ‘sub-workflow’. Default value | | |
| | is False. | | |
| Replica- | Specifies the number of | Number | Number |
| number | replicas that can be run | of | |
| | concurrently when the | replicas | |
| | replicable parameter is True. | | |
| | Default value is 1 | | |
| Scheduled- | Specifies exact scheduled | Date/time | String |
| time | execution time of the task | as | |
| | group. When the upstream | defined | |
| | tasks or task groups fail or | in the | |
| | does not complete by the | format of | |
| | scheduled time, this task | ISO | |
| | group shall not run and | 8601 | |
| | report an error. | | |
| Delayed- | Specifies the relative | seconds | Number |
| time | execution time to outputs | | |
| | from upstream tasks or task | | |
| | groups in batch/stepwise | | |
| | execution mode. | | |
| Non- | Specifies whether or not the | N/A | Boolean |
| essential | task group is essential for | | |
| | Workflow to properly process | | |
| | the data, i.e. Workflow may | | |
| | run without this task group | | |
| | is being in idle or running | | |
| | state. It is useful in the | | |
| | stepwise execution mode. The | | |
| | default value is ‘false’. | | |
| Step- | Supports stepwise group | N/A | Object |
| descriptor | execution like stepwise task | | |
| | mode. With this descriptor, | | |
| | task groups can run in | | |
| | different mode specified by | | |
| | the 'step-mode' parameter in | | |
| | the Step Descriptor. This | | |
| | parameter takes effect only | | |
| | when the mode is | | |
| | asynchronous. This parameter | | |
| | is present only for workflows | | |
| | which support step | | |
| | mode execution. | | |

According to one or more example embodiments, the task groups can be defined explicitly in the workflow description (WDD document) from the NBMP source, wherein the edges of the DAG (in the ‘ connection-map’ object) define the boundary of the task groups. For example, a parameter ‘breakable’ determines whether or not the one or more connected tasks can be splitable. When a task is splitable, it can be used to define the boundary of the task groups. This method can be referred to as a ‘manual mode’. In another embodiment, the task group can be defined based on the proximity distances between tasks, calculated by the workflow manager with a predetermined distance calculation equations, for example, as defined in NBMP standard. This method can be referred to as ‘workflow splitting’.

### Detailed Explanation to Task Group Parameters

Mode: The task groups are extended with the parameters which indicate whether the task group is executed in synchronous mode or in asynchronous mode.
In case of synchronous mode task group, the entire workflow is scheduled, allocated and executed together in its entirety. This means, all the tasks and task groups are allocated resources, e.g., MPE resources before the workflow is executed.
In case of asynchronous mode task group, the task group can be scheduled for execution at a later time. This means that the resource allocation for the task group can be performed right before execution. This is an extension of the workflow slice indication via the ‘breakable’ flag in the connection-map to operate for task groups and the point between any two breakable points in a connection map indicate a workflow slice. In order to maintain atomicity and logical boundaries, the task groups identifier corresponds to the workflow slice. This ensures that the step mode execution is aligned with the asynchronous mode execution of the task groups.

### Scope:

The scope of the task group (IDs) is indicated by this parameter. The value of the scope parameter may be either ‘ local’ or ‘global’ or a specific ‘scopeID’. When the value is ‘local’, the task group ID is valid and scheduled within the workflow session or lifecycle. When the value is ‘global’, the task groups belonging to the different workflows can be scheduled together by the workflow manager. When the value has a specific ‘scopeID’, the task groups belonging to different workflows with the same ‘scopeID’ can be scheduled together by the workflow manager.
The scope parameter with global and/or scopeID task groups may result in the workflow manager to wait for a predefined number of workflows to be instantiated simultaneously. This number is defined by the number of workflows for the same task group and available resources.
In different implementation or embodiment, the workflow manager can decide on the threshold depending on the expected number of workflows expected to be executed at a given point of time and the corresponding heuristic resource requirements.
In different implementation or embodiment, the group ID can replace the scope ID to serve the global group functionality across all workflows. That is, the same task group ID may be shared by task groups across multiple workflows.

### Replicable and Number of Replicas:

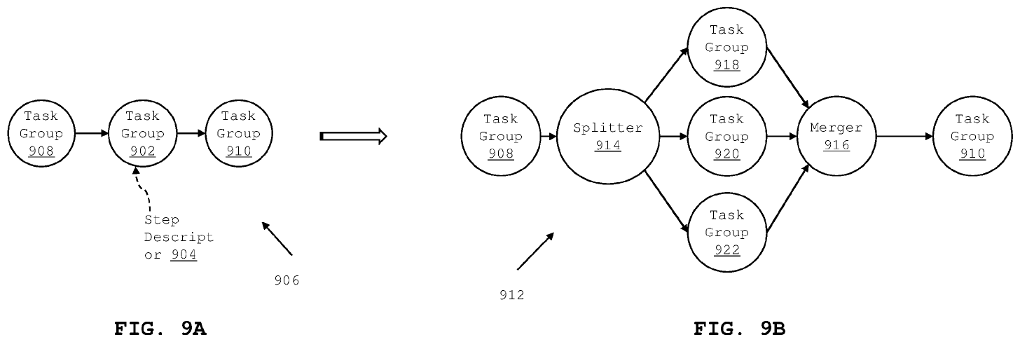

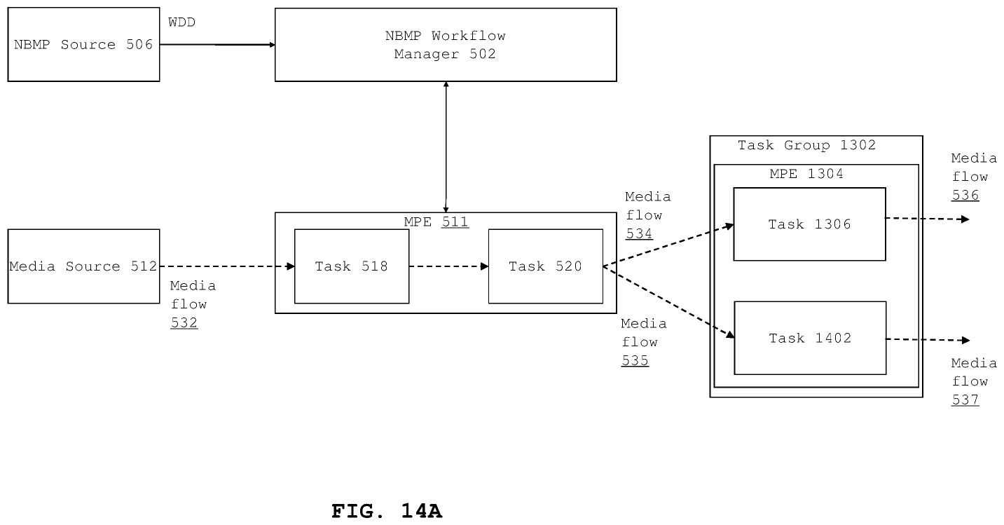

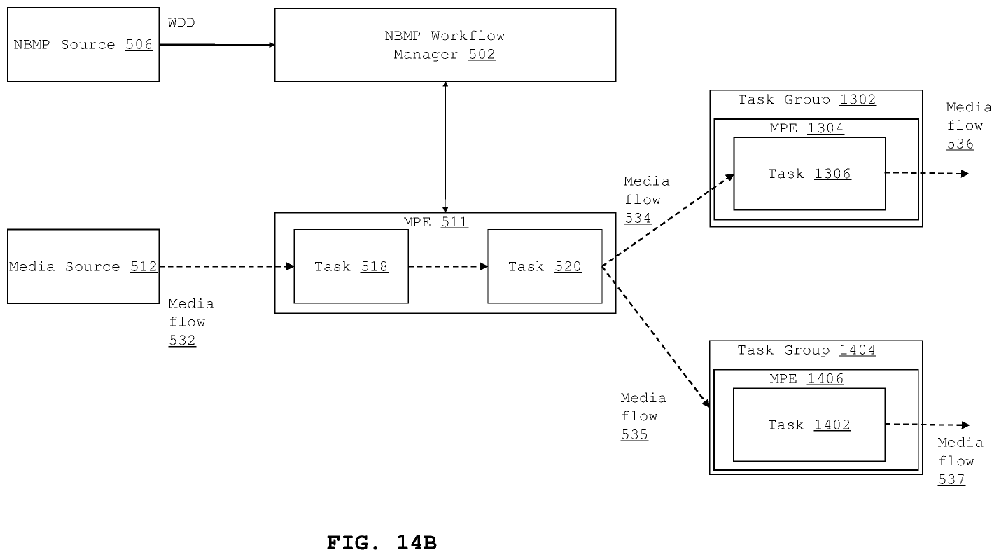

Replicable flag indicates that the tasks within the task group can be replicated by the workflow manager. In different implementation or embodiment, the task group can remain the same with replicated tasks (refer to FIG. 14A). In different implementation or embodiment, the task group can be splitted into new task groups within which replicated tasks can be grouped (as shown in FIG. 14B)
Replica-number parameter indicates the number of clones of tasks in the group. The clone of the tasks can be new instances created from media processing functions.
Step Descriptor: A step descriptor enables stateless processing and/or another way of parallelization of a task or a task group (a group of task). It enables processing data in separate independent steps. At each step, a segment of input(s) is processed that has no dependencies to other segments of that input(s). An example of the task group parallelization by adding splitter and merger before and after the task groups is illustrated with reference to FIG. 9A and FIG. 9B. In FIG. 9A, a task group 902 includes a step descriptor 904 that describes properties of an independent segment processing. As shown in FIG. 9A, a workflow 906 also includes task groups 908 and 910. Using the properties, the workflow 906 in FIG. 9A is converted to a workflow 912 in FIG. 9B, where a splitter 914 and merger 916 tasks are added dynamically and the task group 902 is replicated into multiple instances, for example, a task group 918, a task group 920, and a task group 922, depending on the number of segments specified in the step descriptor 904. The task groups 918, 920, and 922 have properties that are same or substantially same as the properties of the task group 902.

In an embodiment, the replication involving splitter and merger is different from the replication controlled by ‘replicable’ flag and ‘replica-number’, because dynamic tasks like splitter and merger are required in the mode of step descriptor. Simple replication does not need any splitter and merger and the new replicated instances consume the same data (e.g., a media flow 534 in FIG. 14A and FIG. 14B).

### Implementation

### Synchronized Task Group Execution

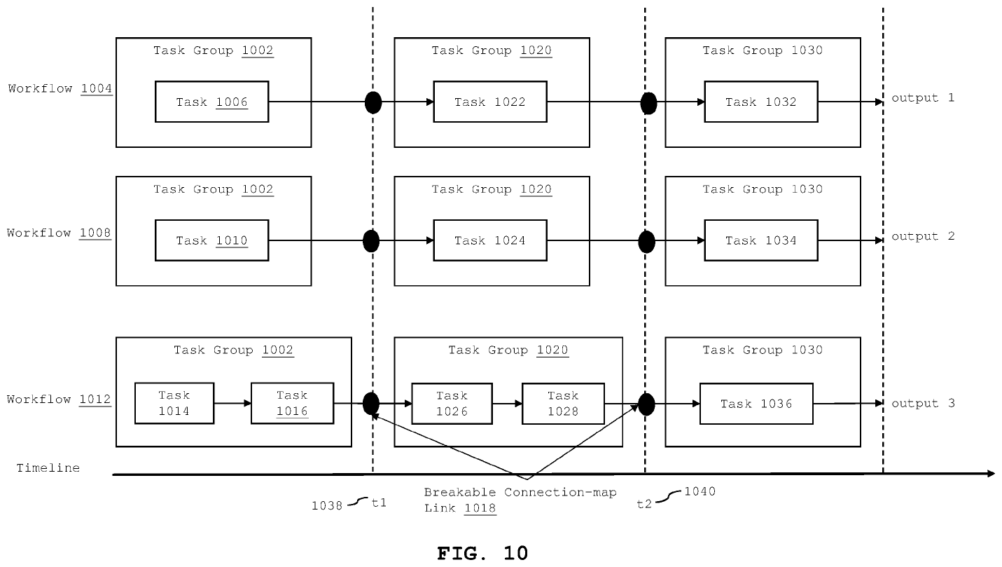

According to one or more example embodiments, the workflow manager can group together all global task groups identifiers (e.g., same global task group names) from multiple workflows with the same identifier and synchronize the executions of the tasks in each execution windows (e.g., t1 and t2 in FIG. 10). Tasks in a next execution window can be late-deployed and executed only after completion of tasks in the previous execution window.

FIG. 10 is a diagram illustrating a synchronized execution configuration in which multi-workflow execution is synchronized, in accordance with an embodiment. For the synchronized execution of multiple workflows, each task group must run in the asynchronous mode. As shown in FIG. 10, when the number of tasks is different in different workflows even with the same task group IDs (e.g., a task group 1002 in a workflow 1004, hosts a task 1006; the task group 1002 in a workflow 1008, hosts a task 1010; and the task group 1002 in a workflow 1012, hosts a task 1014 and a task 1016), the workflow manager can enable such synchronized stepwise mode to wait the completion of all tasks within the same task group before invoking the next execution window. The completion of a task can be signaled and reported as a NBMP notification or report events to the workflow manager during the runtime.

In at least one other example embodiment, the task groups can be used by the workflow manager to schedule computing resources (e.g., the MPEs). In this example, tasks in a next execution window (e.g., time t2 1040) are scheduled, and then deployed and executed only after completion of tasks in the previous execution window (e.g., time t1 1036).

The task groups may be connected with a connection-map link 1018 which is breakable. This will enable allocation of the different task groups in different MPEs.

In an embodiment, similar process or concept is applicable to other task groups ((e.g., a task group 1020 in the workflow 1004, hosting a task 1022; the task group 1020 in the workflow 1008, hosting a task 1024; and the task group 1020 in the workflow 1012, hosting tasks 1026 and 1028) and (e.g., a task group 1030 in the workflow 1004, hosting a task 1032; the task group 1030 in the workflow 1008, hosting a task 1034; and the task group 1030 in the workflow 1012, hosting a task 1036)) in FIG. 10.

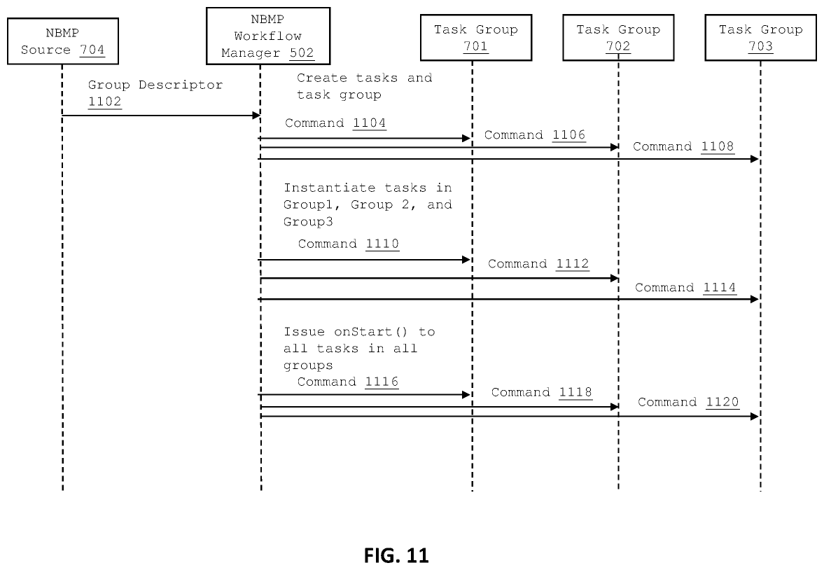

FIG. 11 illustrates synchronous task group execution, in accordance with an embodiment. An NBMP source (e.g., the NBMP source 704) starts a workflow with a group descriptor 1102 and provides it to a NBMP workflow manager (e.g., the workflow manager 502). The workflow manger issues commands (e.g., commands 1104, 1106, and 1108) to create tasks (e.g., the tasks 202 to 216) and tasks groups (e.g., the task groups 701, 702, and 703). Further, the workflow manager issues commands (e.g., commands 1110, 1112, and 1114) to initiate tasks in one or more task groups (e.g., the task groups 701, 702, and 703). Thereafter, the workflow manager issues start commands (e.g., start commands 1116, 1118, and 1120) to start all tasks (e.g., the tasks 202 to 216) in all task groups (e.g., the task groups 701, 702, and 703).

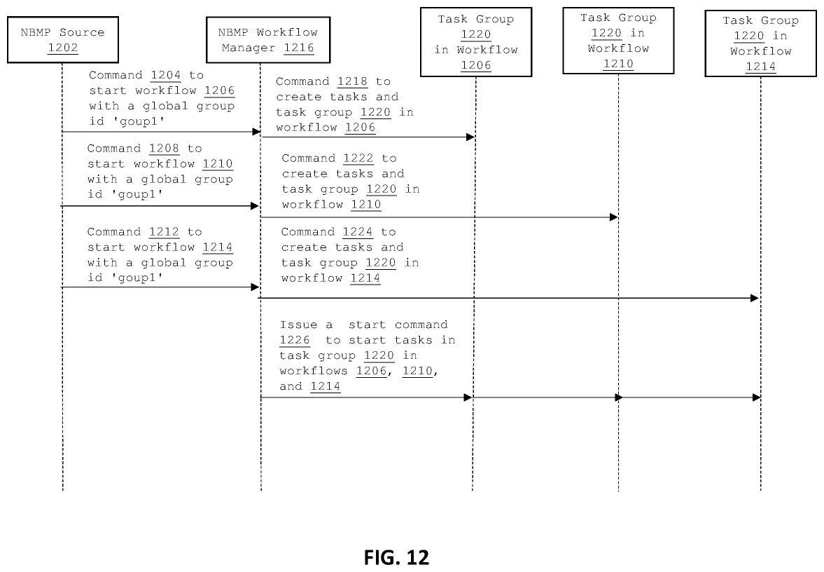

FIG. 12 illustrates asynchronous task group execution, in accordance with an embodiment. An NBMP source 1202 issues a command 1204 to start a workflow 1206 with a global group id ‘goup1’, a command 1208 to start a workflow 1210 with a global group id ‘goup1’, and a command 1212 to start a workflow 1214 with a global group id ‘goup1’. An NBMP workflow manager 1216 receives the commands 1204, 1208, and 1212; and generates a command 1218 to create tasks and a task group 1220 in the workflow 1206, a command 1222 to create tasks and the task group 1220 in the workflow 1210, a command 1224 to create tasks and the task group 1220 the workflow 1214. Thereafter, the workflow manager issues a start command 1226 to start tasks in the group 1220 in the workflows 1206, 1210, and 1214.

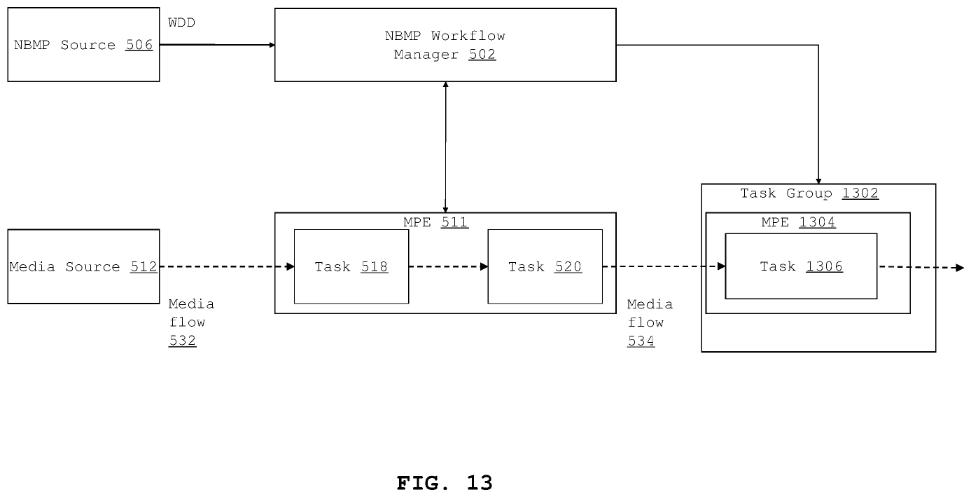

FIG. 13 illustrates a task group before replication, in accordance with an embodiment. FIG. 13 is shown to include the NBMP workflow manager 502, the NBMP source 506, the MPE 511, the media source 512, the task 518, the task 520, the media flow 532, and the media flow 534, which are already described with reference to FIG. 5. FIG. 13 also includes a task group 1302 which is defined to include a task 1306, which runs inside an MPE 1304.

FIG. 14A illustrates a task group after replication, in accordance with an embodiment. FIG. 14A is shown to include the NBMP workflow manager 502, the NBMP source 506, the MPE 511, the media source 512, the task 518, the task 520, the media flow 532, the media flow 534, the media flow 535, the media flow 536, and the media flow 537. FIG. 14A also includes a task group 1302, which is defined to include the tasks 1306 and 1402, which run inside the MPE 1304. The task 520 may be replicated to the tasks 1306 and 1402; and the media flow 534 may be split or duplicated to task 1306 and 1402. After the replication of the task 520, the task group 1302 includes the tasks 1306 and 1402. In this embodiment, the task 520 may be replicated in one task group, e.g., the task group 1302. In an embodiment, the tasks 1306 and 1402 are duplicate or clone of the task 520. The output media flows 536 and 537 of tasks 1306 and 1402 may be merged as one media flow by the merger 916, which is described with reference to FIG. 9A; or may be handled independently by downlink tasks or the media sink 524, which is described with reference to FIG. 5.

FIG. 14B illustrates a task group after replication, in accordance with another embodiment. FIG. 14B is shown to include the NBMP workflow manager 502, the NBMP source 506, the MPE 511, the media source 512, the task 518, the task 520, the media flow 532, and the media flow 534, the media flow 535, the media flow 536, and the media flow 537. FIG. 14B also includes the task group 1302, which is defined to include the task 1306, which runs inside the MPE 1304. 14B further includes a task group 1404, which is defined to include a task 1402, which runs inside a new MPE 1406. The task 520 is replicated into the tasks 1306 and 1402; and the media flow 534 may be split or duplicated to the task 1306 and 1402. After the replication of the task 520, the task group 1302 includes the task 1306 and the task group 1404 includes the task 1402. In this embodiment, the task 520 is replicated into two different task groups, e.g., the task groups 1302 and 1404. In an embodiment, the tasks 1306 and 1402 are duplicate or clone of the task 520. In this embodiment, the relationship of task groups (e.g., the task groups 1302 and 1404) and MPEs (e.g., the MPEs 1304 and 1406) is one example. As described in FIG. 8, tasks (e.g., the tasks 1306 and 1402) of two task groups (e.g., the task group 1302 and 1404) may run inside the same MPE (e.g., the MPE 1304 or 1406). In this example, the MPEs (e.g., the MPEs 1304 and 1406) may be the same physical processing environment. The output media flows 536 and 537 of tasks 1306 and 1402 may be merged as one media flow by the merger 916, which is described with reference to FIG. 9A; or handled independently by downlink tasks or the media sink 524, which is described with reference to FIG. 5.

In another embodiment, the task group may be represented or shadowed by the media processing entity (MPE). For example, features including parameters of a task group can be defined as properties of an MPE. In this embodiment, the MPE serves as both the physical and virtual container for a task management.

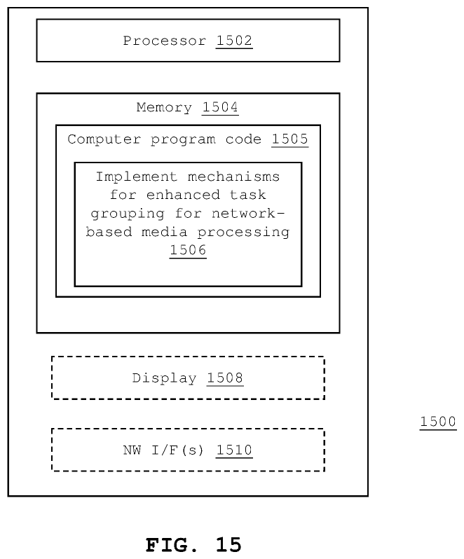

FIG. 15 is a diagram illustrating an example apparatus 1500, which may be implemented in hardware and configured to implement mechanisms for enhanced task grouping for network-based media processing, based on the examples described herein. The apparatus 1500 comprises at least one processor 1502, at least one non-transitory memory 1504 including computer program code, wherein the at least one memory 1504 and the computer program code 1505 are configured to, with the at least one processor 1502, cause the apparatus 1500 to implement mechanisms for enhanced task grouping for network-based media processing 1506. The apparatus 1500 optionally includes a display 1508 that may be used to display content during rendering. The apparatus 1500 optionally includes one or more network (NW) interfaces (I/F(s)) 1510. The NW I/F(s) 1510 may be wired and/or wireless and communicate over the Internet/other network(s) via any communication technique. The NW I/F(s) 1510 may comprise one or more transmitters and one or more receivers. The N/W I/F(s) 1510 may comprise standard well-known components such as an amplifier, filter, frequency-converter, (de) modulator, and encoder/decoder circuitry (ies) and one or more antennas. Some example of the apparatus 1500 include, but are not limited to, a media source, a media sink, a network based media processing source, a user equipment, a workflow manager, and a server. Some other examples, of the apparatus include, the apparatus 50 of FIG. 1 and apparatus 400 of FIG. 4.

The apparatus 1500 may be a remote, virtual or cloud apparatus. The at least one memory 1504 may be implemented using any suitable data storage technology, such as semiconductor based memory devices, flash memory, magnetic memory devices and systems, optical memory devices and systems, fixed memory and removable memory. The at least one memory 1504 may comprise a database for storing data. The apparatus 1500 need not comprise each of the features mentioned, or may comprise other features as well. The apparatus 1500 may correspond to or be another embodiment of the apparatus 50 shown in FIG. 1 and FIG. 2, or any of the apparatuses shown in FIG. 3. The apparatus 1500 may correspond to or be another embodiment of the apparatuses, including UE 110, RAN node 170, or network element(s) 190.

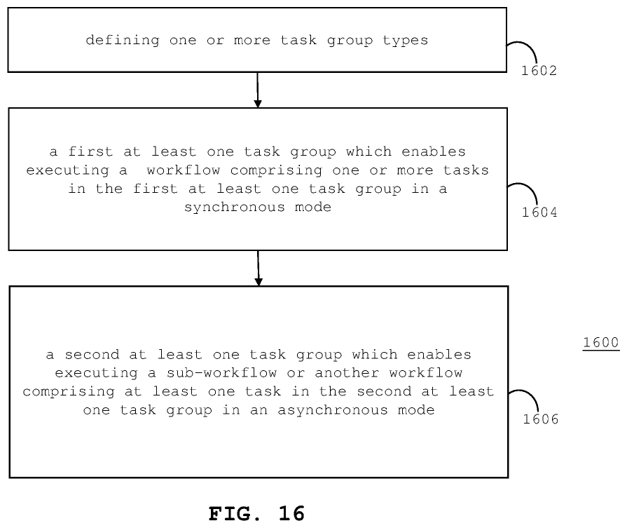

FIG. 16 is a flowchart illustrating operations performed for implementing mechanisms for enhanced task grouping for network-based media processing, such as by the apparatus 1500 of FIG. 15. As shown in block 1602, the apparatus includes means, such as the processor 1502, for defining one or more task group types, wherein the one or more task group types comprise one or more of a first at least one task group and a second at least one task group. As shown in block 1604, the apparatus includes means, such as the processor 1502, where the first at least one task group which enables executing a first workflow comprising one or more tasks in a synchronous mode. In an embodiment, the synchronous mode comprises simultaneous allocation of one or more resources for the one or more tasks and the first at least one task group in the first workflow. In an additional or alternate embodiment, the one or more tasks in the first at least one task group in the synchronous mode are executed simultaneously. As shown in block 1606, the apparatus includes means, such as the processor 1502, where the second at least one task group which enables executing a second workflow comprising one or more tasks in an asynchronous mode. In an embodiment, the asynchronous mode comprises possibility for allocation of resources and execution of one or more task groups in a workflow at a later scheduled time than the start of the workflow.

In an embodiment, the synchronous mode and asynchronous mode need not be present in the same workflow. For example, a workflow which enables executing all the task and task groups in a workflow simultaneously by allocating the necessary resources is a synchronous mode task group. Such task groups are the synchronous task groups.

The synchronous and asynchronous modes are two different types of task groups. In an embodiment, the same workflow may include synchronous mode task groups and asynchronous mode task groups. A workflow, e.g., workflows, that are not step mode may use synchronous mode task groups. A workflow that supports step mode may use asynchronous mode task groups to facilitate resource allocation at a later or scheduled time. The asynchronous mode task groups are the ones which may be allocated at a later scheduled time, such task groups can also be used to start sub-workflows.

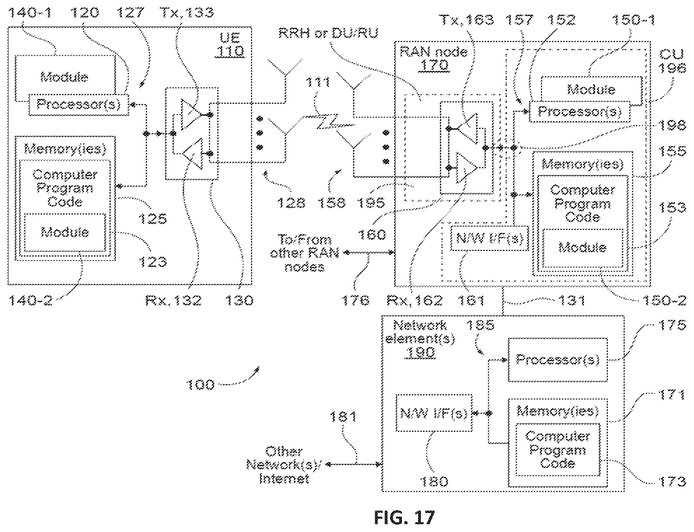

Turning to FIG. 17, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless 100 network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a unit, virtual or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured to implement mechanisms for enhanced task grouping for network-based media processing based on the examples described herein. Computer program code 173 may also be configured to implement mechanisms for enhanced task grouping for network-based media processing environment.

As described above, FIG. 16 includes a flowchart of an apparatus (e.g., 50, 400, or 1500), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 58, 125, 404, 1504, or 125) of an apparatus employing an embodiment of the present invention and executed by processing circuitry (e.g., 56, 402, 120 or 1502) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowcharts of FIG. 16. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-39. (canceled)

40. An apparatus comprising:
at least one processor; and
at least one non-transitory memory including computer program code;
wherein the at least one memory and the computer program code are configured to, with the at least one processor, cause the apparatus at least to perform:
define one or more task group types, wherein the one or more task group types comprise one or more of:
a first at least one task group which enables executing a workflow comprising one or more tasks in the first at least one task group in a synchronous mode and
a second at least one task group which enables executing a sub-workflow or another workflow comprising at least one task in the second at least one task group in an asynchronous mode.

41. The apparatus of claim 40, wherein the second at least one task group comprises at least one task corresponding to a subset of the workflow or the another workflow which are executed in a step mode.

42. The apparatus of claim 41, wherein the apparatus is further caused to define a scope, wherein the scope comprises a local scope or a global scope, and wherein a task group associated with the local scope is scheduled and instantiated by a control plane depending on the resource condition and requirements of a single workflow, and wherein a task group associated with the global scope is scheduled, allocated and executed based on the resource requirements corresponding to a predefined threshold number of workflows.

43. The apparatus of claim 40, wherein the first at least one task group and the second at least one task group reside or are executed in at least one of:
a network based media processing (NBMP) source;
a central cloud; or
a multi-access edge computing (MEC) cloud or a sink device.

44. The apparatus of claim 40, wherein a task group is a logical group of tasks that are deployed on a same MPE (media processing entity), or MPEs that are within a predetermined distance.

45. The apparatus of claim 40, wherein a task group comprises one or more tasks running in one or more MPEs.

46. The apparatus of claim 40, wherein the first at least one task group and the second at least one task group comprise one or more of following parameters:
a breakable parameter for determining whether or not a connected task is splitable, when the connected task is splitable, the connected task is used to define a boundary of the at the first at least one task group and the second at least one task group;
a mode parameter for indicating whether a task group is executed in the synchronous mode or in the asynchronous mode;
a replicable flag parameter for indicating that the tasks within the task group are capable of being replicated by a workflow manager or the task group is capable of being divided into new task groups for new replicated tasks; or
a step descriptor for enabling at least one of a stateless processing or a parallelization of a task or a task group.

47. The apparatus of claim 40, wherein the one or more tasks in the first at least one task group that are in the synchronous mode are executed simultaneously.

48. A method comprising:
defining one or more task group types, wherein the one or more task group types comprise one or more of:
a first at least one task group which enables executing a workflow comprising one or more tasks in the first at least one task group in a synchronous mode; and
a second at least one task group which enables executing a sub-workflow or another workflow comprising at least one task in the second at least one task group in an asynchronous mode.

49. The method of claim 48, wherein the second at least one task group comprises at least one task corresponding to a subset of the workflow or the another workflow which are executed in a step mode.

50. The method of claim 49 further comprising defining a scope, wherein the scope comprises a local scope or a global scope, and wherein a task group associated with the local scope is scheduled and instantiated by a control plane depending on the resource condition and requirements of a single workflow, and wherein a task group associated with the global scope is scheduled, allocated and executed based on the resource requirements corresponding to a predefined threshold number of workflows.

51. The method of claim 48, wherein the first at least one task group and the second at least one task group reside or are executed in at least one of:
a network based media processing (NBMP) source;
a central cloud; or
a multi-access edge computing (MEC) cloud or a sink device.

52. The method of claim 48, wherein a task group is a logical group of tasks that are deployed on a same media processing entity (MPE), or MPEs that are within a predetermined distance.

53. The method of claim 48, wherein a task group comprises one or more tasks running in one or more MPEs.

54. The method of claim 48, wherein the first at least one task group and the second at least one task group comprises one or more of following parameters:
a breakable parameter determines whether or not a connected task is splitable, when the connected task is splitable, the connected task is used to define a boundary of the at the first at least one task group and the second at least one task group;
a mode parameter indicates whether a task group is executed in the synchronous mode or in the asynchronous mode;
a replicable flag parameter indicates that the tasks within a group are capable of being replicated by a workflow manager or the task group is capable of being divided into new task groups for new replicated tasks; or
a step descriptor enables at least one of a stateless processing or a parallelization of a task or a task group.

55. The method of claim 48, wherein the one or more tasks in the first at least one task group in the synchronous mode are executed simultaneously.

56. A non-transitory computer readable medium comprising program instructions for causing an apparatus to perform at least the following:
defining one or more task group types, wherein the one or more task group types comprise one or more of:
a first at least one task group which enables executing a workflow comprising one or more tasks in the first at least one task group in a synchronous mode; and
a second at least one task group which enables executing a sub-workflow or another workflow comprising at least one task in the second at least one task group in an asynchronous mode.

57. The non-transitory computer readable medium of claim 56, wherein a task group is a logical group of tasks that are deployed on a same MPE (media processing entity), or MPEs that are within a predetermined distance.

58. The non-transitory computer readable medium of claim 56, wherein a task group comprises one or more tasks running in one or more MPEs.

59. The non-transitory computer readable medium of claim 56, wherein the first at least one task group and the second at least one task group comprise one or more of following parameters:
a breakable parameter for determining whether or not a connected task is splitable, when the connected task is splitable, the connected task is used to define a boundary of the at the first at least one task group and the second at least one task group;
a mode parameter for indicating whether a task group is executed in the synchronous mode or in the asynchronous mode;
a replicable flag parameter for indicating that the tasks within the task group are capable of being replicated by a workflow manager or the task group is capable of being divided into new task groups for new replicated tasks; or
a step descriptor for enabling at least one of a stateless processing or a parallelization of a task or a task group.
